(19) United States
(12) Patent Application Publication
(10) Pub. No.: US 2011/0078291 A1
(43) Pub. Date: Mar. 31, 2011

(54) DISTRIBUTED PERFORMANCE MONITORING IN SOFT REAL-TIME DISTRIBUTED SYSTEMS

(75) Inventors: Danny Bickson, Haifa (IL); Gidon Gershinsky, Haifa (IL); Konstantin Shagin, Haifa (IL)

(73) Assignee: International Business Machines Corporation, Armonk, NY (US)

(21) Appl. No.: 12/569,954

(22) Filed: Sep. 30, 2009

(51) Int. Cl. G06F 15/173; G06F 15/177

(52) U.S. Cl. 709/221; 709/224

(57) ABSTRACT

A novel and useful framework, system and method of monitoring one or more performance parameters (e.g., distributed system performance), filtering the performance parameters data collected and identifying one or more performance parameters that affect one or more target performance measures. This can be achieved in the case of a delay parameter, for example, by determining the root-cause of the increased delay and taking corrective actions in order to avoid violation of the timeliness constraints. The present invention is a statistical based performance monitoring mechanism that uses statistical signal processing techniques and is applicable, for example, in soft real-time distributed systems. The monitoring framework efficiently and distributively characterizes the behavior of the varying network conditions as a stochastic process and performs root-cause analysis to detecting the parameters which affect one or more target performance measures, e.g., latency. Once the affecting parameters are determined, corrective action is optionally taken.

### FIELD OF THE INVENTION

The present invention relates to the field of performance monitoring, and more particularly relates to statistics based distributed performance monitoring in soft real-time distributed systems.

### SUMMARY OF THE INVENTION

A novel and useful framework, system and method of monitoring one or more performance parameters (e.g., distributed system performance), filtering the performance parameters data collected and identifying one or more performance parameters that affect one or more target performance measures. This can be achieved in the case of a delay parameter, for example, by determining the root-cause of the increased delay and taking corrective actions in order to avoid violation of the timeliness constraints. The present invention is a statistical based performance monitoring mechanism that uses statistical signal processing techniques and is applicable, for example, in soft real-time distributed systems. The monitoring framework efficiently and distributively characterizes the behavior of the varying network conditions as a stochastic process and performs root-cause analysis to detecting the parameters which affect one or more target performance measures, e.g., latency. Once the affecting parameters are determined, corrective action is optionally taken.

There is thus provided in accordance with the invention, a method of distributed performance monitoring of a distributed system having a plurality of nodes, the method comprising the steps of monitoring a plurality of performance parameters at each node in the system, filtering the performance parameter data collected during the monitoring step and identifying one or more performance parameters that affect one or more target performance measures.

There is also provided in accordance with the invention, a method of distributed performance monitoring of a distributed system incorporating a plurality of nodes, the method comprising the steps of at each node, periodically measuring a plurality of performance parameters, filtering the performance parameter data collected during the measuring step and characterizing the behavior of the filtered performance parameter data as a stochastic process to detect performance parameters that affect one or more target performance measures.

There is further provided in accordance with the invention, a system for distributed performance monitoring of a distributed system comprising a local performance monitor at each node operative to measure a plurality of performance parameters, a filter operative to filter the measured performance parameters and an identification module operative to determine the performance parameters having maximum affect on one or more target performance measures.

There is also provided in accordance with the invention, a computer program product for distributed performance monitoring of a distributed system incorporating a plurality of nodes, the computer program product comprising a computer usable medium having computer usable code embodied therewith, the computer usable program code comprising computer usable code configured for monitoring a plurality of performance parameters at each node in the system, computer usable code configured for filtering the performance parameter data collected during the monitoring step and computer usable code configured for identifying one or more performance parameters that affect one or more target performance measures.

### BRIEF DESCRIPTION OF THE DRAWINGS

The invention is herein described, by way of example only, with reference to the accompanying drawings, wherein:

FIG. 1 is a block diagram illustrating an example computer processing system adapted to implement the performance monitoring mechanism of the present invention;

FIG. 2 is a flow diagram illustrating an example distributed performance monitoring mechanism of the present invention;

FIG. 3 is a block diagram illustrating an example distributed performance monitoring system of the present invention;

FIG. 4 is a diagram illustrating the schematic operation of the linear regression method;

FIG. 5 is a diagram illustrating the joint covariance matrix calculated by the Kalman filter algorithm;

FIG. 6 is a graph illustrating Kalman filter smoothing of the packets/sec parameter;

FIG. 7 is a diagram illustrating the distributed linear regression results of a transmitter with low memory;

FIG. 8 is a diagram illustrating the improved distributed linear regression results of a transmitter with low memory;

FIG. 9 is a diagram illustrating a randomly created overlay tree topology of ten nodes;

FIG. 10 is a diagram illustrating the regression results for the tree topology with ten nodes; and

FIG. 11 is a graph illustrating the quality of the linear regression for the same experiment, comparing the actual transmitter latency with the predicted latency by the linear model.

### DETAILED DESCRIPTION OF THE INVENTION

### Notation Used Throughout

The following notation is used throughout this document:

| Term | Definition |
|---|---|
| ASCII | American Standard Code for Information Interchange |
| ASIC | Application Specific Integrated Circuit |
| AWGN | Additive White Gaussian Nose |
| CDROM | Compact Disc Read Only Memory |
| CPU | Central Processing Unit |
| DSP | Digital Signal Processor |
| EEROM | Electrically Erasable Read Only Memory |
| EPROM | Erasable Programmable Read-Only Memory |
| FPGA | Field Programmable Gate Array |
| FTP | File Transfer Protocol |
| GLS | Generalized Least Squares |
| HTTP | Hyper-Text Transport Protocol |
| LAN | Local Area Network |
| NIC | Network Interface Card |
| OS | Operating System |
| RAM | Random Access Memory |
| RF | Radio Frequency |
| ROM | Read Only Memory |
| SAN | Storage Area Network |
| TCP | Transport Control Protocol |
| UDP | User Datagram Protocol |
| URL | Uniform Resource Locator |
| WAN | Wide Area Network |

### DETAILED DESCRIPTION OF THE INVENTION

The present invention is a framework, system and method that monitors distributed system performance, determines the root-cause of the increased delay and takes corrective actions in order to avoid violation of the timeliness constraints. The monitoring framework employs a distributed root-cause analysis.

The present invention is a statistical based performance monitoring mechanism applicable, for example, in soft real-time distributed systems. The mechanism uses well-known techniques from statistical signal processing in constructing the distributed monitoring framework of the invention. The mechanism efficiently and distributively characterizes the behavior of the varying network conditions as a stochastic process and performs root-cause analysis for detecting the parameters which affect one or more target performance measures, e.g., latency.

Several advantages of the mechanism include: (1) using a statistical approach which is independent of the system characteristics such as operating system, transport protocol and network structure; (2) the mechanism requires minimal domain-specific knowledge to accurately determine the root-cause; (3) system operation is distributed, without a centralized computing node; (4) system adapts to network changes as quickly as possible; (5) the system does not rely on software implementation, OS and networking details (i.e. a “black-box” approach).

As will be appreciated by one skilled in the art, the present invention may be embodied as a system, method, computer program product or any combination thereof. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented or supported by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

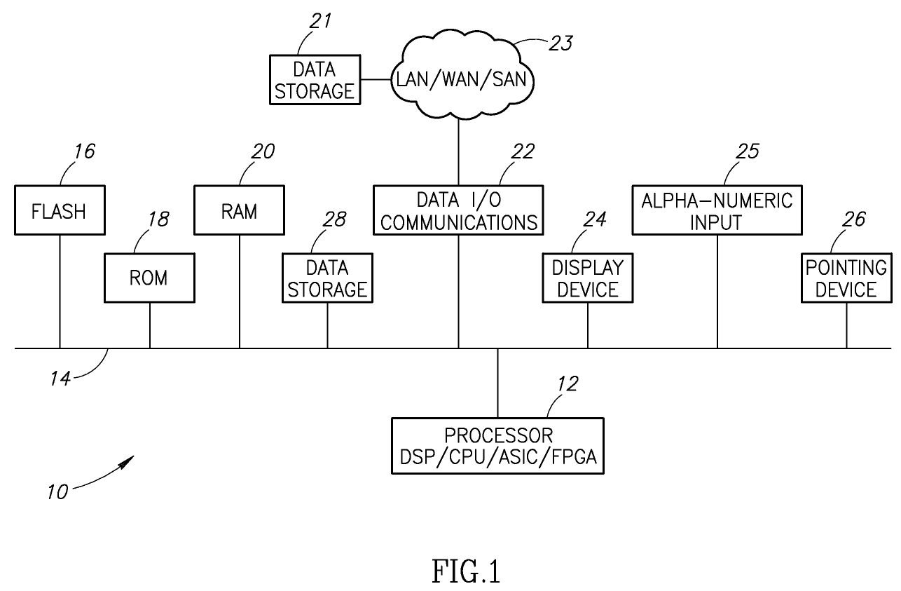

A block diagram illustrating an example computer processing system adapted to implement the system and methods of the present invention is shown in FIG. 1. The computer system, generally referenced 10, comprises a processor 12 which may comprise a digital signal processor (DSP), central processing unit (CPU), microcontroller, microprocessor, microcomputer, ASIC or FPGA core. The system also comprises static read only memory 18 and dynamic main memory 20 all in communication with the processor. The processor is also in communication, via bus 14, with a number of peripheral devices that are also included in the computer system. Peripheral devices coupled to the bus include a display device 24 (e.g., monitor), alpha-numeric input device 25 (e.g., keyboard) and pointing device 26 (e.g., mouse, tablet, etc.)

The computer system is connected to one or more external networks such as a LAN or WAN 23 via communication lines connected to the system via data I/O communications interface 22 (e.g., network interface card or NIC). The network adapters 22 coupled to the system enable the data processing system to become coupled to other data processing systems or remote printers or storage devices through intervening private or public networks. Modems, cable modem and Ethernet cards are just a few of the currently available types of network adapters. The system also comprises magnetic or semiconductor based storage device 21 and/or 28 for storing application programs and data. The system comprises computer readable storage medium that may include any suitable memory means, including but not limited to, magnetic storage, optical storage, semiconductor volatile or non-volatile memory or any other memory storage device.

Software adapted to implement the system and methods of the present invention is adapted to reside on a computer readable medium, such as a magnetic disk within a disk drive unit. Alternatively, the computer readable medium may comprise a floppy disk, removable hard disk, Flash memory 16, EEROM based memory, bubble memory storage, ROM storage, distribution media, intermediate storage media, execution memory of a computer, and any other medium or device capable of storing for later reading by a computer a computer program implementing the method of this invention. The software adapted to implement the system and methods of the present invention may also reside, in whole or in part, in the static or dynamic main memories or in firmware within the processor of the computer system (i.e. within microcontroller, microprocessor or microcomputer internal memory).

Other digital computer system configurations can also be employed to implement the system and methods of the present invention, and to the extent that a particular system configuration is capable of implementing the system and methods of this invention, it is equivalent to the representative digital computer system of FIG. 1 and within the spirit and scope of this invention.

Once they are programmed to perform particular functions pursuant to instructions from program software that implements the system and methods of this invention, such digital computer systems in effect become special purpose computers particular to the method of this invention. The techniques necessary for this are well-known to those skilled in the art of computer systems.

It is noted that computer programs implementing the system and methods of this invention will commonly be distributed to users on a distribution medium such as floppy disk or CD-ROM or may be downloaded over a network such as the Internet using FTP, HTTP, or other suitable protocols. From there, they will often be copied to a hard disk or a similar intermediate storage medium. When the programs are to be run, they will be loaded either from their distribution medium or their intermediate storage medium into the execution memory of the computer, configuring the computer to act in accordance with the method of this invention. All these operations are well-known to those skilled in the art of computer systems.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or by combinations of special purpose hardware and computer instructions.

### Distributed Monitoring Mechanism

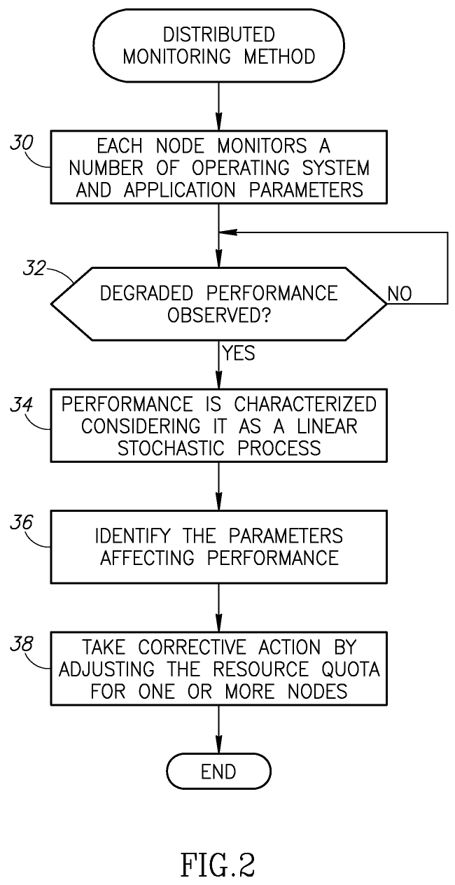

A flow diagram illustrating an example distributed performance monitoring mechanism of the present invention is shown in FIG. 2. The framework operates as follows. Each node monitors a large number of various local operating system and application parameters (step 30). If degraded performance is observed anywhere in the network (step 32), the nodes jointly characterize the performance by regarding it as a linear stochastic process, using statistical signal processing tools (step 34). Subsequently, a joint root-cause analysis computation is performed to identify the parameters which affect one or more target performance measures (step 36). Optionally, once the reasons for degradation are determined, corrective action is taken by adjusting the resource quota of one or more nodes (step 38). Note that adjustment of the resource quotas is not the only option. Alternatively, other actions can be taken, e.g., changing the data flow path or reconfiguring the application, etc.

Note that the root-cause analysis technique is general and can be applied in many other distributed systems, and it is not limited to the soft real-time domain. The main performance measures are tunable and can be set, for example, to CPU consumption, bandwidth utilization etc. The performance monitoring mechanism is also applicable to debugging whereby anomalous software behavior such as software bugs and deadlocks is detected. The mechanism is further applicable to in load balancing, minimization of deployed resource, hot-spot detection etc.

Note further that the mechanism of the invention scales up to large domains in a hierarchical manner where each sub domain performs monitoring locally, filters out the relevant parameters which affect performance. The mechanism is run again between the different domains. The mechanism assumes a dynamic model, where software behavior and resource requirements are not known a priori. Further, the mechanism is implemented as a distributed computing model in which there is no central server that receives and processes all information.

The mechanism is directed to real time resource allocation where resource usage is captured, for example, in a time window of seconds (rather than daily). The process is characterized as a linearly noisy stochastic process. This allows greater flexibility in describing the process behavior over time, by characterizing joint covariance of measured parameters. Root-cause analysis of parameters which affect system performance is performed.

### Mathematical Background

A brief overview of the mathematical background needed for describing the algorithms of the present invention will now be provided followed by a description of how the algorithms are used in the performance monitoring systems and methods of the invention.

The Kalman filter is a well-known efficient iterative algorithm that estimates the state of a discrete-time controlled process xεRⁿ that is governed by the linear stochastic difference equation

xₖ=Axₖ₋₁+ωₖ₋₁ (1)

With a measurement xεR^{m} that is zₖ=Hxₖ+vₖ. The random variables wₖ (so what is zₖ?) and vₖ represent the process and measurement AWGN noise, respectively. p(w)≈N(0,Q),p(v)≈N(0,R). The discrete Kalman filter update equations are as follows below.

The prediction step is as follows:

\hat{x}ₖ=A\hat{x}ₖ₋₁⁻

Pₖ⁻=APₖ₋₁⁻A^{T}+Q (2)

The measurement step is as follows

Kₖ=Pₖ⁻H^{T}(HPₖ⁻H^{T}+R)⁻¹

\hat{x}ₖ=\hat{x}ₖ⁻+Kₖ(zₖ−H\hat{x}ₖ⁻)

Pₖ=(I−KₖH)Pₖ⁻ (3)

Where I is the identify matrix.

The algorithm operates in rounds where in round k the estimates Kₖ, \hat{x}ₖ, Pₖ are computed, incorporating the (noisy) measurement zₖ obtained in this round. The output of the algorithm are the mean vector \hat{x}ₖ and the covariance matrix Pₖ.

In the well-known generalized least squares (GLS) method, given an observation matrix A of size n×k, and a target vector b of size 1×n, the linear regression computes a vector x which is the least squares solution to the quadratic cost function

$${min}_{x} {‖ Ax - b ‖}_{2}^{2} \qquad ( 4 )$$

The algebraic solution is x=(A^{T}A)⁻A^{T}b, where x can be referred as the hidden weight parameters, which given the observation matrix A, explains the target vector b.

The linear regression method has an underlying assumption that the measured parameters are not correlated. As was experimentally determined, however, the measured parameters are highly correlated. For example, on a certain queue the number of get/put operations in each given second is correlated. In this case, it is better to use the generalized least squares (GLS) method. In this method, we minimize the quadratic cost function

$${min}_{x} {( Ax - b )}^{T} {P}^{- 1} ( Ax - b ) \qquad ( 5 )$$

Where P is the inverse covariance matrix of the observed data. In this case, the optimal solution (i.e. output) is

x=(A^{T}P⁻¹A)⁻¹A^{T}P⁻¹b (6)

which is the best linear unbiased estimator.

The Gaussian Belief Propagation (GaBP) is a well-known efficient iterative algorithm for solving a system of linear equations of the type Ax=b. The GLS method computation can be computed efficiently and distributively using the GaBP algorithm. Further, it is known how to compute the Kalman filter distributively and efficiently over a communication network.

The input to the GaBP algorithm is the matrix A and the vector b, the output is the vector x=A⁻¹b. The algorithm is a distributed algorithm, which means that each node gets a part of the matrix A and the vector b as input, and outputs a portion of the vector x as output. The algorithm may not converge, but in case it converges it is known to converge to the correct solution.

### Example Embodiment

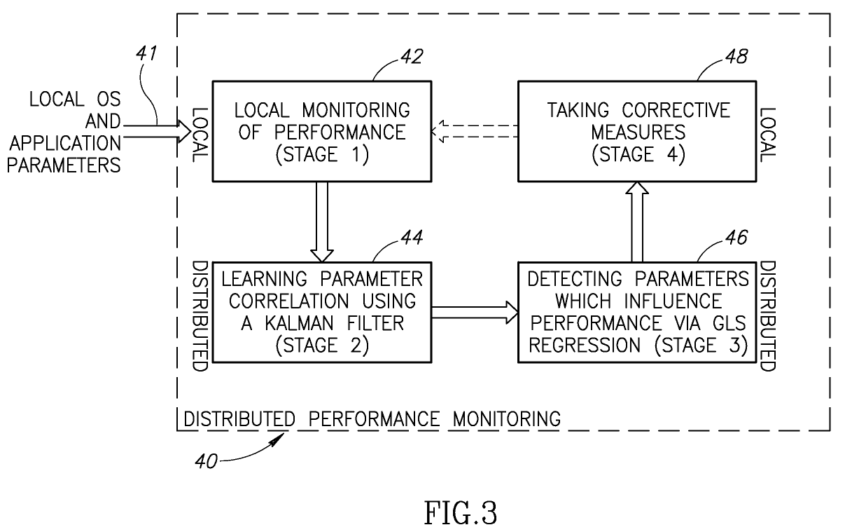

In an example embodiment of the invention, the performance monitoring mechanism comprises four stages, as shown in FIG. 3. The first stage (Stage 1) 42 is the data collection stage. In this stage, the nodes locally monitor their measurable performance parameters and record the relevant parameters in a local data structure. Data collected includes local operating system (OS) and application data. The data collection is done in the background every configured time frame Δt, and has minimal effect on performance. During normal operation, all messages arrive before their soft real-time deadlines. Thus, there is no need to continue and compute the next stages. Whenever one of the nodes detects deterioration in performance (e.g., a message is almost late), it notifies the other nodes that it wishes to compute the second stage.

The second stage (Stage 2) 44 performs the Kalman filter computation distributively. The input to the second stage comprises the local data parameters collected in the first stage. Its output comprises the mean and joint covariance matrix which characterize the correlation between the different parameters (possibly collected on different machines). The underlying algorithm used for computing the Kalman filter updates is the GaBP algorithm described supra. The output of the second stage can be also used for reporting performance to the upper layer application. For example, the mean and variance of the effective bandwidth can be measured.

The third stage (Stage 3) 46 computes the GLS method (described supra) for performing regression. The target performance measure for the regression can be chosen dynamically or a priori, e.g., total message latency. The input to the third stage comprises the parameter data collected during the first stage and the covariance matrix computed in the second stage. The output of the third stage is a weight parameter vector. The weight parameter vector has an intuitive meaning of providing a linear model for the data collected. The computed linear model enables the identification of those parameters that influence performance the most (i.e. parameters with the highest absolute weights). In addition, the computed weights can be used to compute predictions for the node behavior, e.g., how an increase of 10 MB of buffer memory will affect the total latency.

Finally, the fourth stage (Stage 4) 48, which is optional, uses the output of the third stage for taking corrective measures. For example, if the main cause of increased latency is related to insufficient memory, the relevant node requests additional memory resources from the operating system. The fourth stage is performed locally and is optional, depending on the type of application and the availability of resources.

A more detailed description including implementation and computational aspects of each of the four stages is provided hereinbelow.

Stage 1: Local Data Collection:

In this stage, participating nodes locally monitor their performance every Δt seconds. Each node record performance parameters, such as memory and CPU consumption, bandwidth utilization and other relevant parameters. Based on the monitored software, information about internal data structures like files, sockets, threads, available buffers etc. is also monitored. The monitored parameters are stored locally, in an internal data structure representing the matrix A, of size n×k, where n is the history size, and k is the number of measured parameters. Note, that at this stage, the monitoring mechanism does not care about the meaning of the monitored parameters, regarding all monitored parameters equally as linear stochastic noisy processes.

Stage 2: Kalman Filter

The second stage is performed distributively over the network, where participating nodes compute the Kalman filter algorithm (described supra). The input to the computation is the matrix A recorded in the data collection stage, and the assumed levels of noise Q and R. The output of this computation is the mean vector \hat{x} and the joint covariance matrix P (Equation 3). The joint covariance matrix characterizes correlation between measured parameters, possibly spanning different nodes.

Well-known statistical signal processing techniques are used to compute the Kalman filter using the GaBP iterative algorithm (described supra). One benefit of using the efficient distributed iterative algorithm is faster convergence (i.e. reduced number of iterations) relative to classical linear algebra iterative methods. This in turn, allows the monitoring framework to adapt promptly to changes in the network. The output of the Kalman filter algorithm \hat{x} is computed in each node locally. Each computing node has the part of the output which is the mean value of its own parameters. In the example embodiment described herein, to reduce computation cost, the full matrix P is not computed, but rather the rows of P which represent significant performance parameters selected a priori.

Stage 3: GLS Regression

The third stage is performed distributively over the network as well, for computing the GLS regression (Equation 6). The input to this stage is the joint covariance matrix P computed in the second stage, the recorded parameters matrix A, and the performance target b. The GLS regression solves the least squares problem in Equation 5 above. The output of the GLS computation is a weight vector x which assigns weights to all of the measured parameters (Equation 6). By selecting the parameters (any number depending on the implementation) with the highest absolute magnitude from the vector x, the recorded parameters that significantly influence the performance target can be determined. For example, the parameters in vector x selected may comprise those whose differences between neighboring parameters are greater or less than a predetermined threshold. Note that each weight is associated with a different parameter and is a unitless entity.

The results of this computation are received locally, which means that each node computes the weights of its own parameters. Additionally, the nodes compute distributively the top ten (or other number) maximal values. The GLS method is computed again using the GaBP algorithm. The main benefit of using the GaBP algorithm for both tasks (i.e. Kalman filter and GLS method computation) is that the algorithm only needs to be implemented and tested once.

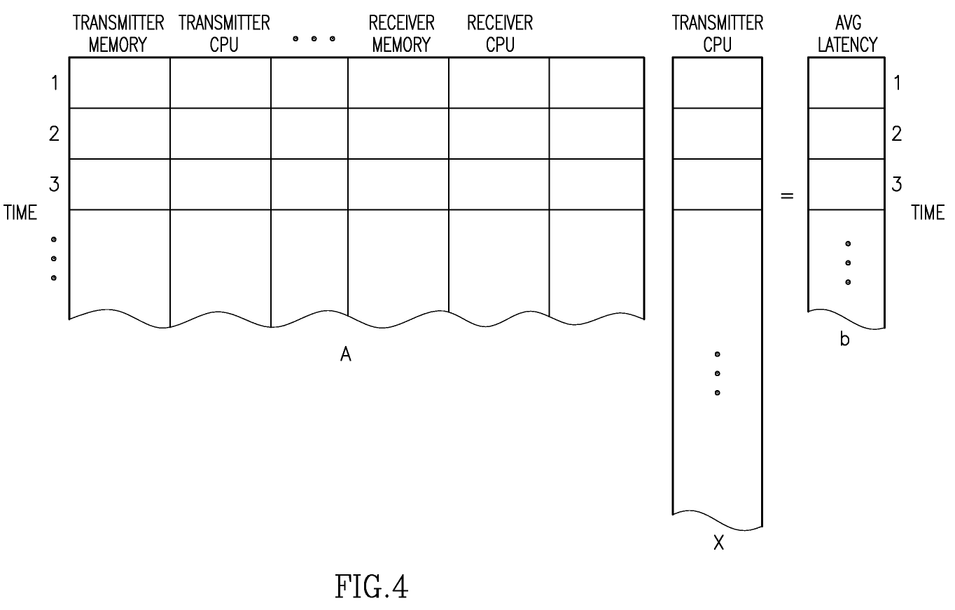

A diagram illustrating the schematic operation of the linear regression method is shown in FIG. 4. The input to the linear regression method comprises (1) the collected matrix A 82 of recorded measured parameters and (2) the target system performance parameters matrix b 86. The output of the linear regression method is the weight vector x 84 which assigns the parameters relative weights. See Equations 5 and 6 above.

Note that the Kalman filter state may be optional since it results in higher computational effort that Stage 3. In the event the Kalman filter is not computed, linear regression is computed instead of the GLS regression. The linear regression solves the problem shown in Equation 4 where the solution is x=(A^{T}A)⁻¹A^{T}b.

Stage 4: Corrective Measures

When a node detects that a local parameter computed in Stage 3 is highly correlated to the target performance measure, it attempts to take corrective measures. This step is optional and depends on the application and/or the operating system support. Examples of local system resources include CPU quota, thread priority, memory allocation and bandwidth allocation. Note that resources may be either increased or decreased based on the regression results. For implementing this stage, a mapping between the measured parameters and the relevant resource needs to be defined by the system designer.

For example, the process virtual memory size TRANSMITTER PROCESS VSIZE is related to memory allocated to the process by the operating system. The performance monitoring framework (i.e. Stages 1, 2, 3) is not aware of the semantic meaning of this parameter. To take corrective measures, the mapping between parameters and resources is essential and requires domain specific knowledge. Considering the virtual memory example above, the mapping links TRANSMITTER PROCESS VSIZE to the memory quota of the transmitter process. Whenever this parameter is selected to by the linear regression performed in Stage 3 as a parameter which significantly affects performance, a request to the operating system to increase the virtual memory quota is performed.

The results of Stage 3 processing can be used to determine the amount to increase or decrease a certain resource quota. The regression algorithm assigns weights to examined system parameters to explain the performance target in the linear model. More formally, Ax≈b where x is the weight vector, A are the recorded parameters and b is the performance target measure. Now, assume xᵢ is the most significant parameter selected by the regression, representing resource i. It is possible to increase xᵢ by 20%, for example, i.e. \hat{x}=x+0.2*xᵢ, and examine the result of the increase on the predicted performance, by using the equation \hat{b}=A\hat{x}. Specifically, in soft real-time distributed systems, the effect of an increase of 10% in transmitter memory can be observed by computing the predicted effect on total message latency.

### Experimental Results

The TransFab messaging fabric is a high-performance soft real-time messaging middleware. It runs on top of the networking infrastructure and implements a set of publish/subscribe and point-to-point services with explicitly enforced limits on times for end-to-end data delivery. The inventors have incorporated the performance monitoring framework as a part of the TransFab overlay in Java. In experiments performed by the inventors, the TransFab node recorded 190 parameters which characterize the current performance. Among them, memory usage, process information (obtained from the \proc file system in Linux), current bandwidth, number of incoming/outgoing messages, state of internal data structures such as queues and buffer pools, number of get/put operations on them, etc. The unreliable UDP transport scheme was used whose timeliness properties are more predictable then those of TCP. TransFab incorporates reliability mechanisms that guaranties n-order delivery of messages. A transmitter discards a message only after all receivers have acknowledged the receipt of the message. When a receiver detects a missing message, it requests its retransmission by sending a negative acknowledgement to the transmitter.

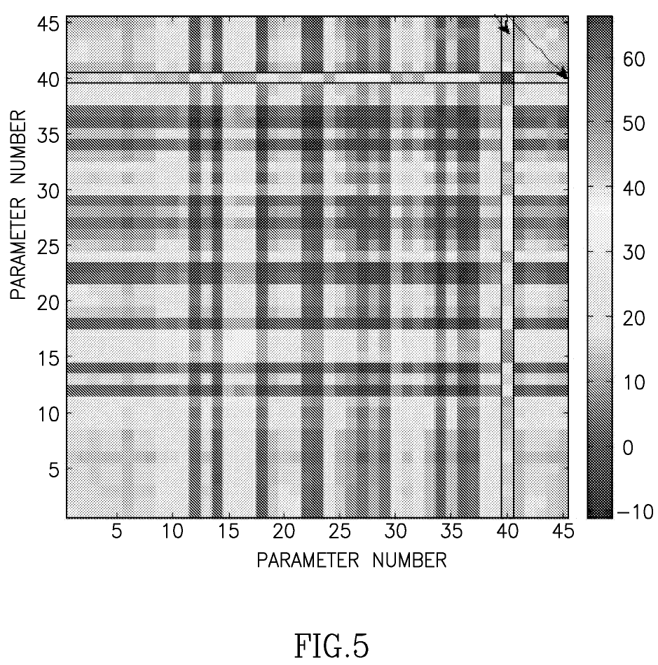

For testing the distributed monitoring framework of the invention, an experiment was performed whose main performance measure was the total packet latency. Transmitter and receiver TransFab nodes ran on two machines on the same LAN. The transmitter was configured to send 10,000 messages/sec each of size 8 kb. Memory allocation of both nodes was 100 Mb. The experiment ran for 500 seconds, where history size n was set to 100 seconds. During the experiment, stage 1 (data collection) of the monitoring was performed every Δt=1 second. At time 250 seconds, the Kalman filter algorithm was computed distributively by the nodes. By performing the Kalman filter computation (stage 2) using information collected from two nodes, which of the collected parameters that influence the total packet latency were able to be identified. Furthermore, insights about system performance, which could not be computed by using only local information was gained as well. To save bandwidth, nodes locally filter out constant parameters out of the matrix A. Thus, the input to the Kalman filter algorithm was reduced to 45 significant parameters. FIG. 5 presents a joint covariance matrix calculated by the Kalman filter algorithm (computed in the second stage) using this example. Column 40 and row 40 represent the dependency of total packet latency in various parameters measured by the receiver. The covariance matrix includes parameters captured by the transmitter (columns 1 to 23) and parameters recorded by the receiver (columns 24 to 45). As shown in FIG. 5, the total latency of packets, even in a small setup of only two nodes, on two idle machines, is strongly correlated with dozens of parameters. Furthermore, the total latency depends on parameters from both the sender and the receiver. The covariance matrix plots the dependence of pairs of parameters, where the goal is determine the reasons for message delay. In one embodiment, the following optimization can be used wherein the full covariance matrix is not computed but rather only the rows which represent correlation with the target parameters (in this example only row 40).

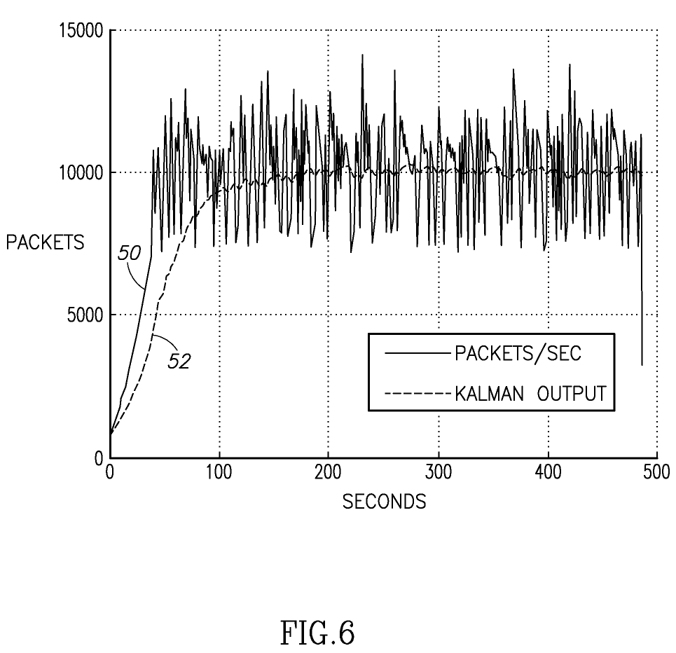

A graph illustrating Kalman filter smoothing of the packets/sec parameter is shown in FIG. 6. Shown is the additional Kalman filter output 52, which is the mean vector xₖ. In this example, the mean packets/sec parameter 50 is from two node experiment presented herein. The assumed error levels Q, R define the level of smoothing. In this example, Q, R are diagonal matrices with error level σ²=0.01. The mean value and computed variance provide the nodes with additional information about performance, which could be used for monitoring and debugging purposes.

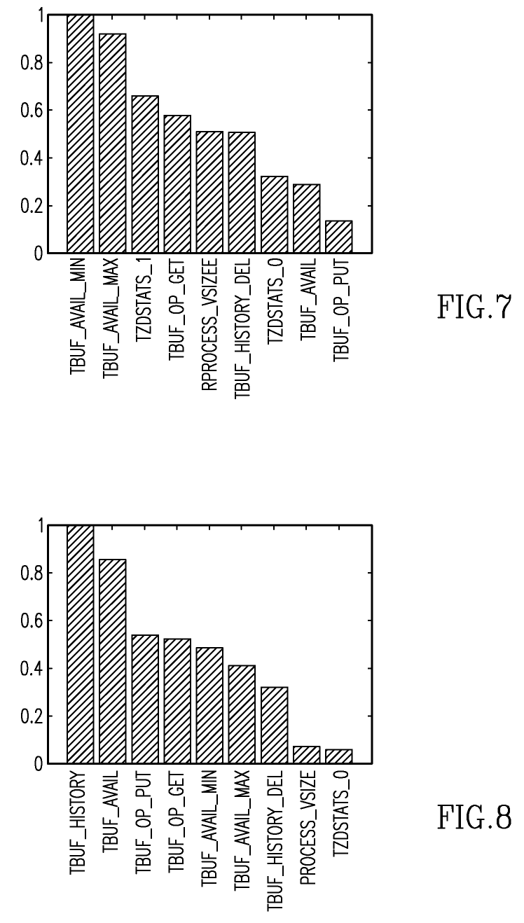

The experiment was repeated, but this time at time 150 seconds and the transmitting machine memory was reduced to 2.4 Mb for outgoing message buffers. At time 155, the receiving nodes detected local degradation in performance, and computed stages 2 (i.e. Kalman filtering) and 3 (i.e. linear regression) where the history parameter was set to n=100 seconds, for finding the parameters which affect the total packets latency. FIG. 7 presents the distributed linear regression results of a transmitter with low memory (performed by the two TransFab nodes). As can be seen, out of the top five causes of increased latency, three are related to the transmitter memory buffers. In accordance with the invention, the GLS method was used to improve the quality of ranking. FIG. 8 shows the improved regression results for a transmitter with low memory, using the GLS method. After application of the GLS method, seven out of the top nine parameters that cause increased latency are related to transmitter memory buffers.

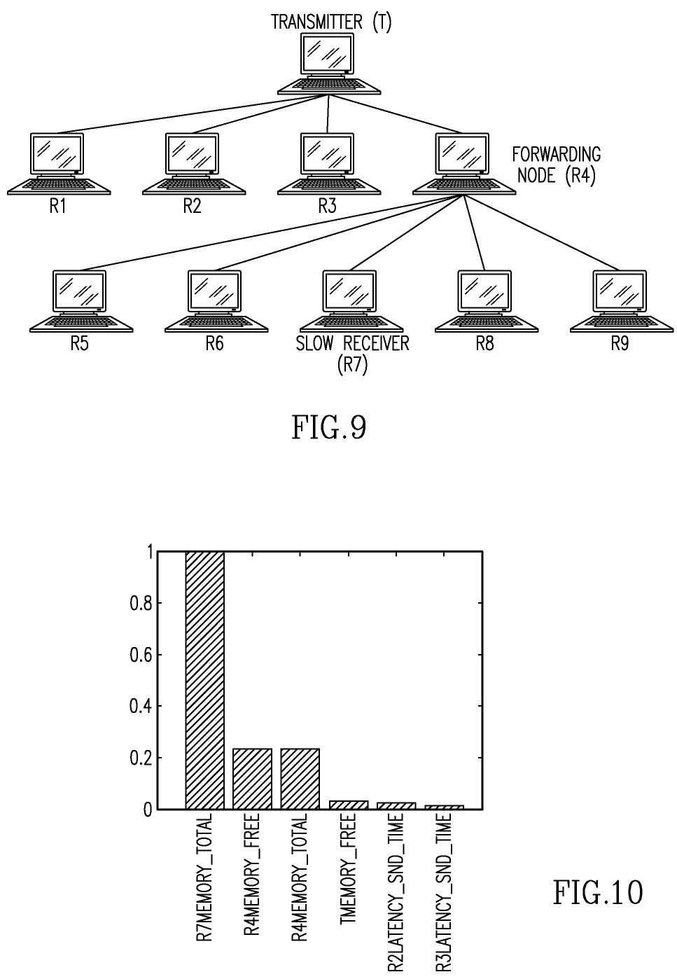

An additional experiment was performed which demonstrates the applicability of the monitoring framework of the invention. The goal of the experiment was to show, given a randomly chosen faulty node, the ability of the monitoring framework to correctly identify the faulty node and the type of the fault. At runtime, an overlay tree topology of ten nodes was created randomly, as shown in FIG. 9. The topology, forwarding node and type of error (in this case low memory receiver) are randomly selected at runtime. Regression is performed jointly on all ten nodes, where the target is the transmitter latency. A single transmitter T (the root note), transmits a flow of 3,000 packets of size 8 kbps to its children, at a rate of 24 Mb for each flow. The nodes have no global knowledge of the network topology. Specifically, the transmitter is not aware which of its direct children are forwarding nodes and which nodes are tree leaves. Next, one of faults listed in Table 1 below was selected at random to be assigned to one of the tree nodes. The experiment was run for 500 seconds, after which the nodes jointly compute the regression results, where the target was the transmitter latency. Note that transmitter latency is defined as the total time messages wait in transmitter buffers from their submission by the application until they are actually transmitted over the wire.

TABLE 1
Possible host and network faults selected randomly at runtime

| Error | Description |
|---|---|
| A | No error |
| B | Low CPU receiver |
| C | Low CPU transmitter |
| D | Channel loss |
| E | Low memory receiver |
| F | Low memory transmitter |

Regression results for the tree topology with ten nodes is shown in FIG. 10. The low memory receiver (R7) memory is detected to be the first cause of transmitter latency. The forwarding node's memory (R4) is the second cause for transmitter latency. Finally, transmitter (T) memory is detected as the fourth cause which affects transmitter latency.

This experiment was repeated multiple times, each time with a different topology, a different faulty node and a different fault was selected. An example topology generated at random is shown in FIG. 9. The faulty node was assigned fault E, i.e. a low memory receiver. The matching regression results are presented in FIG. 10. The results indicate, that the memory of the low memory node is identified as the first cause which affects transmitter latency. The forwarding node's memory is identified as the second and third causes of the transmitter latency. Finally, the transmitter memory is identified as the fourth cause of transmitter latency. Besides detecting the faulty node, the critical path between the transmitter and the low memory receiver is identified correctly as the congested path.

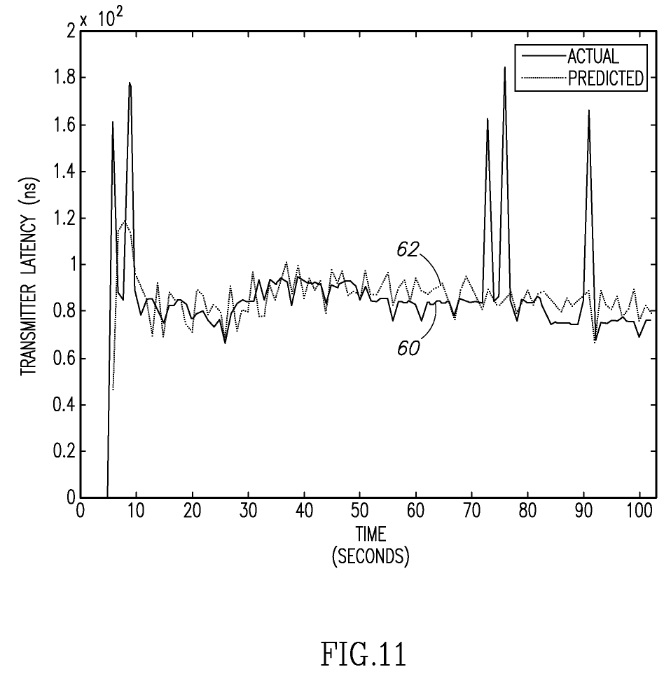

FIG. 11 is a graph illustrating the quality of the linear regression for the same experiment, comparing the actual transmitter latency with the predicted latency by the linear model. More formally, we first compute x using Equation 6 and then plot Ax versus b. The desired result is that the actual latency 60 and predicted latency 62 computed by the linear model are as close as possible to each other. Using real world data, however, it is difficult to obtain perfect predictions, most likely because the linear model is a simplification of the real world. This figure shows that the overall fit between the predicted and actual latency is relatively good.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A method of distributed performance monitoring of a distributed system having a plurality of nodes, said method comprising the steps of:
monitoring a plurality of performance parameters at each node in said system;
filtering the performance parameter data collected during the monitoring step;
identifying one or more performance parameters that affect one or more target performance measures; and
wherein said steps of monitoring, filtering and identifying are implemented in either of computer hardware configured to perform said monitoring, filtering and identifying steps, and computer software embodied in a non-transitory, tangible, computer-readable storage medium.

2. The method according to claim 1, wherein said performance parameters comprise local operating system parameters.

3. The method according to claim 1, wherein said performance parameters comprise application parameters.

4. The method according to claim 1, wherein said step of filtering comprises applying Kalman filtering to said performance parameter data.

5. The method according to claim 1, wherein said step of identifying comprises the step of performing a joint root cause analysis computation to identify the performance parameters that affect said target performance measure.

6. The method according to claim 1, further comprising the step of taking corrective action in response to the results of said step of identifying by adjusting one or more local system resources of one or more nodes.

7. A method of distributed performance monitoring of a distributed system incorporating a plurality of nodes, said method comprising the steps of:
at each node, periodically measuring a plurality of performance parameters;
filtering the performance parameter data collected during said measuring step;
characterizing the behavior of said filtered performance parameter data as a stochastic process to detect performance parameters that affect one or more target performance measures; and
wherein said steps of measuring, filtering and characterizing are implemented in either of computer hardware configured to perform said measuring, filtering and characterizing steps, and computer software embodied in a non-transitory, tangible, computer-readable storage medium.

8. The method according to claim 7, wherein said performance parameters comprise local operating system parameters.

9. The method according to claim 7, wherein said performance parameters comprise application parameters.

10. The method according to claim 7, wherein said step of filtering comprises applying Kalman filtering to said performance parameter data.

11. The method according to claim 7, wherein said step of detecting comprises performing root cause analysis on said filtered performance parameter data.

12. The method according to claim 7, wherein said step of detecting comprises the step of computing generalized least squares (GLS) regression with reference to a particular target performance measure.

13. The method according to claim 12, wherein said generalized least squares (GLS) regression identifies which performance parameters exert maximum influence on a target performance measure.

14. The method according to claim 7, further comprising the step of taking corrective action in response to the results of said step of detecting by adjusting one or more local system resources of one or more nodes.

15. A system for distributed performance monitoring of a distributed system, comprising:
a local performance monitor at each node operative to measure a plurality of performance parameters;
a filter operative to filter said measured performance parameters; and
an identification module operative to determine the performance parameters having maximum affect on one or more target performance measures.

16. The system according to claim 15, wherein said identification module operative to detect any performance parameters violating one or more performance requirements.

17. The system according to claim 15, wherein said performance parameters comprise local operating system parameters.

18. The system according to claim 15, wherein said performance parameters comprise application parameters.

19. The system according to claim 15, wherein said filtering comprises means for applying Kalman filtering to said performance parameter data.

20. The system according to claim 15, wherein said identification module comprises means for characterizing the behavior of said filtered performance parameter data as a stochastic process and for computing a generalized least squares (GLS) regression with reference to a particular target performance measure.

21. A computer program product for distributed performance monitoring of a distributed system incorporating a plurality of nodes, the computer program product comprising:
a computer usable medium having computer usable code embodied therewith, the computer usable program code comprising:
computer usable code configured for monitoring a plurality of performance parameters at each node in said system;
computer usable code configured for filtering the performance parameter data collected during the monitoring step; and
computer usable code configured for identifying one or more performance parameters that affect one or more target performance measures.

22. The computer program product according to claim 21, wherein said step of filtering comprises applying Kalman filtering to said performance parameter data.

23. The computer program product according to claim 21, wherein said step of identifying comprises the step of performing a joint root cause analysis computation to identify the performance parameters that affect said target performance measure.

24. The computer program product according to claim 21, further comprising computer usable code configured for taking corrective action in response to the results of said step of identifying by adjusting one or more local system resources of one or more nodes.
